(19) United States
(12) Patent Application Publication
(10) Pub. No.: US 2026/0062220 A1
(43) Pub. Date: Mar. 5, 2026

(54) AUTOMATED TOTE TRANSFER SYSTEM

(71) Applicant: NIFCO AMERICA CORP., Canal Winchester, OH (US)

(72) Inventor: Ryan Scott DAUBENMIRE, Lancaster, OH (US)

(21) Appl. No.: 18/820,261

(22) Filed: Aug. 30, 2024

(51) Int. Cl. B65G 1/137; B65G 1/04

(52) U.S. Cl. CPC B65G 1/1378; B65G 1/0485; B65G 2201/0258

(57) ABSTRACT

An automated tote transfer system includes a frame structure including a platform located on one side of the frame structure, an upper ramp extending obliquely upwardly from the platform and having rollers along a length thereof, a lower ramp extending obliquely downwardly from the platform at a side of the upper lamp and having rollers, and guide rails provided above top edges of the lower ramp, the platform and the upper ramp. A robot is located adjacent the platform, wherein the robot is configured to pick up parts transferred to the frame structure, to put into totes located on the frame structure, and to move the totes on the frame structure.

### BACKGROUND OF THE INVENTION

The present invention relates to an automated tote transfer system for collecting parts. More specifically, the present invention relates to an automated system that, by using a robot-controlled arm, collects, stores and transfers parts, such as injection molded parts, from an injection molding machine for shipping with minimal operator support.

### BACKGROUND OF THE INVENTION

When parts are injection-molded by an injection molding machine, after coming out of the injection molding machine, the parts are generally placed on a conveyor belt. These parts are placed on the conveyor belt to allow for cooling time before they are placed in totes which are located at the end of the conveyor belt. An operator replaces each tote once it is full and replace it with an empty tote. This system only allows the operator to be away from the injection molding machine during a time for filling the tote with parts. This limits the number of injection molding machines that one operator can support.

In order to increase the number of injection molding machines that one operator can support at any given time, the present invention has been proposed.

It is an object of this invention to provide an automated tote transfer system, which would allow one operator to support more automated machine, such as injection molding machines, at one time.

Other objects and advantages of the invention will be apparent from the following description of the invention.

### SUMMARY OF THE INVENTION

An automated tote transfer system of the present invention comprises a frame structure including a platform located on one side of the frame structure, an upper ramp extending obliquely upwardly from the platform and having rollers along a length thereof, a lower ramp extending obliquely downwardly from the platform on one side of the upper lamp and having rollers, and guide rails provided above top edges of the lower ramp, the platform and the upper ramp; and a robot located adjacent the platform. The robot is configured to pick up parts transferred to the frame structure, to put into a tote located on the frame structure, and to move the tote on the frame structure.

The tote can be easily moved on the frame structure by the rollers at the upper ramp and the lower lamp.

The automated tote transfer system of the invention further comprises a conveyer table with a powered conveyor belt running across a top thereof to deliver the parts from one side of the conveyer table to another side thereof to be picked up by the robot. In case the parts are injection molded parts, the conveyor table allows the injection molded parts to cool as they move from an injection molding machine to the robot arm.

Also, the automated tote transfer system of the invention further comprises a pick-up device located adjacent to the conveyer table, and to pick-up the parts, such as from the injection molding machine, and deliver the parts onto the conveyer table.

In the invention, the pick-up device picks-up the parts and places the parts onto the conveyer table. The parts on the conveyer table is transferred from the one side of the conveyer table to the another side, and the robot arm picks-up the parts on the conveyer table, and puts the parts into the toes delivered from the upper lamp to the platform and to transfer the toes to the lower lamp.

In particular, an operator places empty totes in line on the upper ramp and starts the robot program. The robot arm lifts the lowest tote up and pulls it onto the platform. The robot arm then fills the tote on the platform with parts coming on the conveyor table. Once the tote on the platform is full, the robot arm pushes the tote off the platform onto the lower ramp. The full tote slides along the rollers to the end of the ramp. The robot arm then reaches over and picks up an empty tote from the lowest position on the upper ramp and pulls it onto platform. Gravity causes another empty totes on the upper ramp to slide along the rollers to the lowest position.

The robot arm continues this process of filling the totes, moving the full totes and getting the empty totes. As a result, the operator is only required to remove full totes and re-supply the empty totes.

This automated transfer system allows the operator more time to support more machines, such as injection molding machines, since the operator no longer has to remove full totes of injection molded parts from the end of the conveyor after each tote is full.

### BRIEF DESCRIPTION OF THE DRAWINGS

The present invention will be more understood with reference to the following descriptions in conjunction with the accompanying drawings.

FIG. 1 shows a rear isometric view of a conveyor frame of the invention.

FIG. 2 shows a front isometric view of the conveyor frame.

FIG. 3 shows an isometric view of a robot arm of the invention.

FIG. 4 shows an isometric view of a control head.

FIG. 5 shows an isometric view of a conveyor table.

FIG. 6 through FIG. 13 show isometric views of an automated tote transfer system and injection molding machine of the invention, in process.

FIG. 14 through FIG. 27 show isometric views of an automated tote conveyor system of the invention, in process.

### DETAILED DESCRIPTION OF THE INVENTION

The present invention will be explained with reference to the drawings.

The detailed description is exemplary in nature and is not intended to limit the invention and uses. Furthermore, there is no intention to be bound by any theory presented by the following detail.

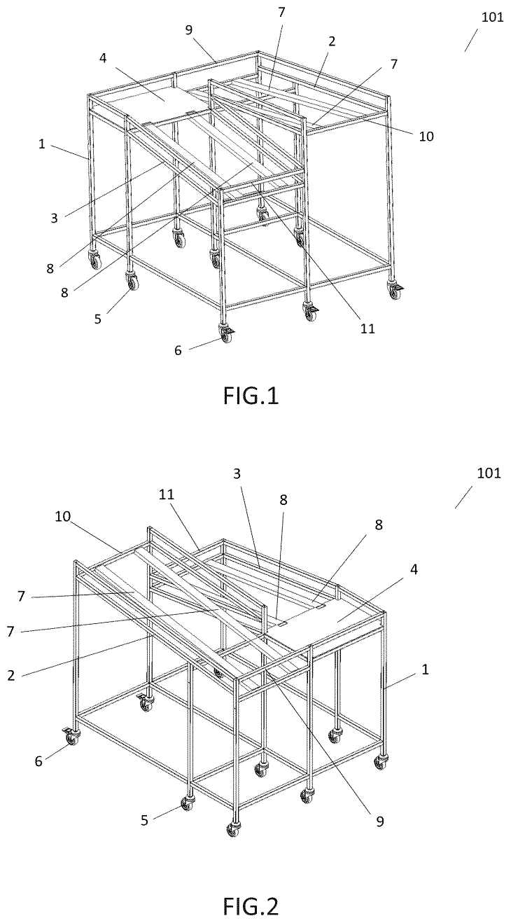

FIG. 1 and FIG. 2 show, respectively, isometric front and rear views of the conveyor frame 101 of the invention. The conveyor frame 101 is a rectangular tubular structure mounted on locking swivel wheels 6 and swivel wheels 5, which forms a platform 4, an upper ramp 2 and a lower ramp 3.

The horizontal platform 4 is located in a front upper left-hand corner of a structure with the lower ramp 3 coming off the back edge of the platform 4 at a downward angle towards the rear of the structure below the platform 4. There are two rows of rollers 8 that run down along the length of the lower ramp 3.

Located in the front upper right-hand corner above the top surface of the platform 4 is the upper ramp 2 running at an upward angle from the platform 4 towards the rear of the structure. There are two rows of rollers 7 that run up from the platform 4 along the length of the upper ramp 2.

The rollers 7, 8 are free rotational rollers and are indicated schematically. However, each of the rollers 7, 8 may be a conveyor or some other device to transfer the parts.

A railing runs around three sides of the lower ramp 3 leaving an open section between the platform 4 and the lower ramp 3 while creating a lower stop 11 at the lowest point of the lower ramp 3. Also, a railing runs around the two sides of the platform 4 leaving open sections with respect to the lower ramp 3 and the upper ramp 2. Further, a railing runs around the three sides of the upper ramp 2 leaving open sections at the highest rear portion of the upper ramp 2 and between the platform and the upper ramp while creating an upper stop 9 in the front of the upper ramp 2.

The locking swivel wheels 6 and the swivel wheels 5 allow the conveyor frame 101 to be movable from location to location while being secured in place when required.

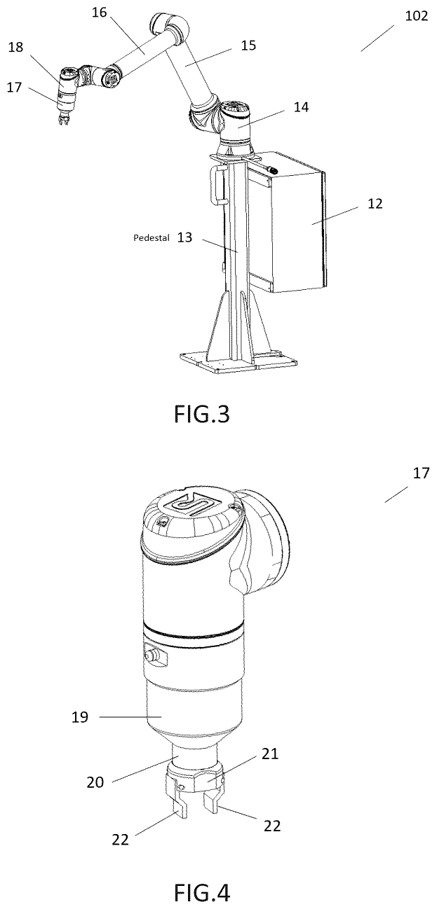

FIG. 3 shows an isometric view of a robot arm 102 that includes a pedestal 13, a control unit 12, a pedestal pivot 14, a lower arm 15, an upper arm 16, a tool pivot 18 and a control head 17. The pedestal 13 is used to securely mount the robot on the floor. The control unit 12 is mounted to the pedestal 13 and contains all the electronics to control the robot arm 102. The lower arm 15, the upper arm 16 and the tool pivot are used to articulate the movement of the control head 17 of the robot arm 102.

FIG. 4 shows the components of the control head 17 of the robot arm 102. The control head 17 includes a tool holder 19, a tool 20, a grip head 21 and grip fingers 22. The tool holder 19 holds the tool 20 that contains the grip head 21 from which the grip fingers 22 pivot.

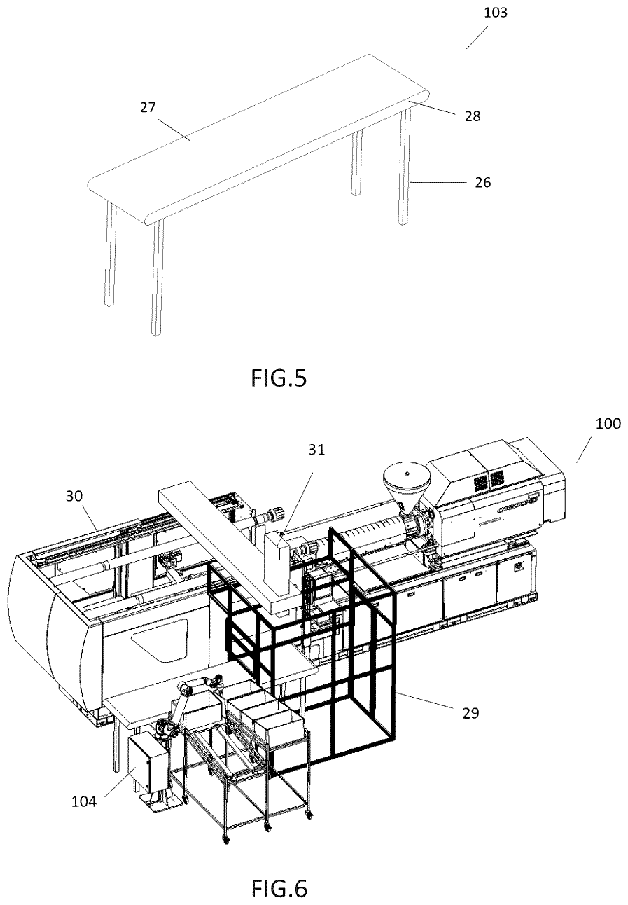

FIG. 5 shows the components of a conveyor table 103. The conveyer table 103 comprises frames 26, a conveyor top 28, and a conveyor belt 27. The frames 26 hold the conveyor top 28 which contains the conveyor belt 27 moving around the conveyor top to create a continuous loop in one-way direction of the conveyor belt 27.

FIG. 6 through FIG. 13 show an automated tote transfer system 104 of the invention applied to an injection molding system 100 for delivering injection molded parts made by the injection molding system 100.

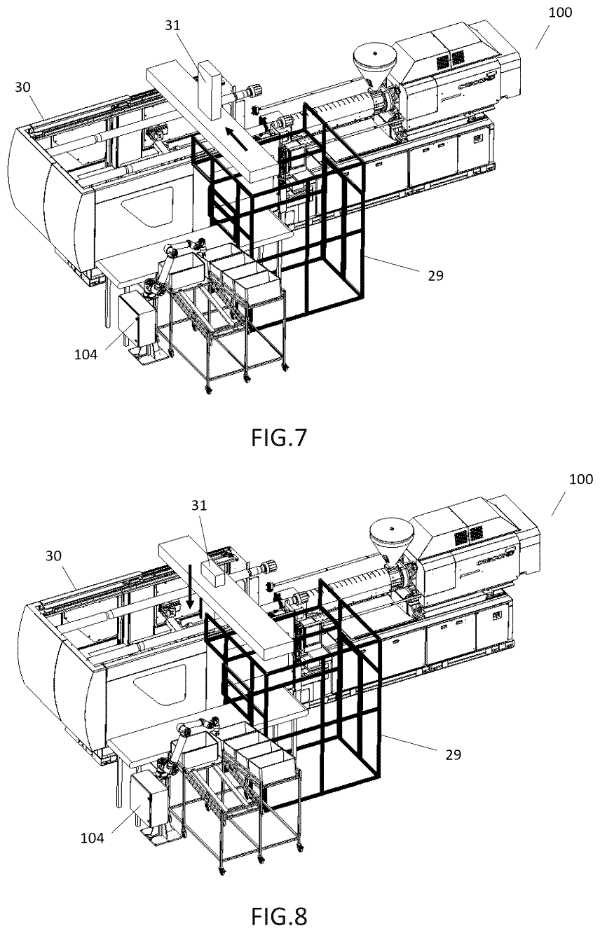

The injection molding system 100 comprises an injection molding machine 30, a pick up arm 31, a safety cage 29, and an automated tote transfer system 104. After plastic is injected into a tooling of the injection molding machine 30, the tooling opens allowing the pick-up arm 31 to move over the top of the injection molding machine 30 (FIG. 6 to FIG. 7) and inside to grab molded parts 24 from the tooling (FIG. 8).

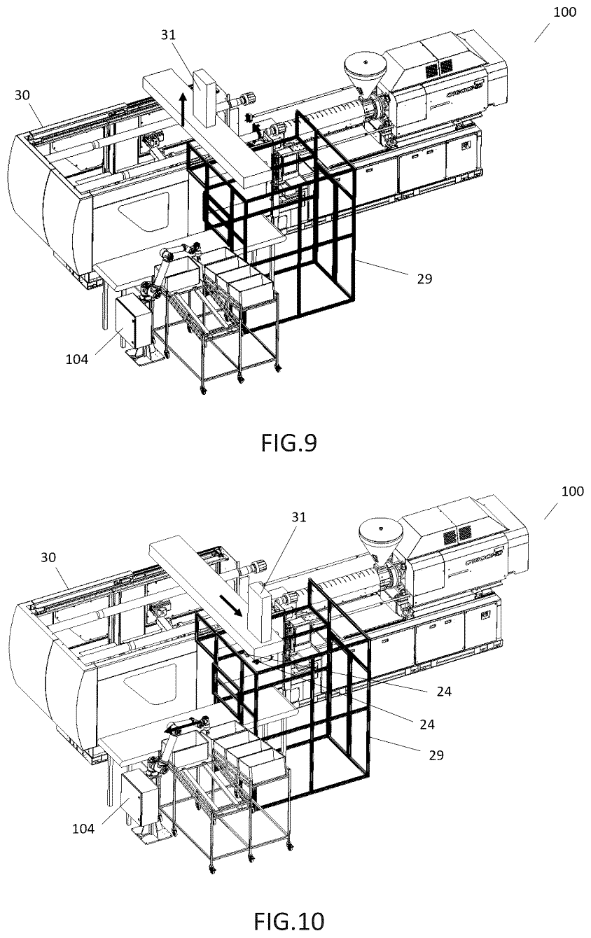

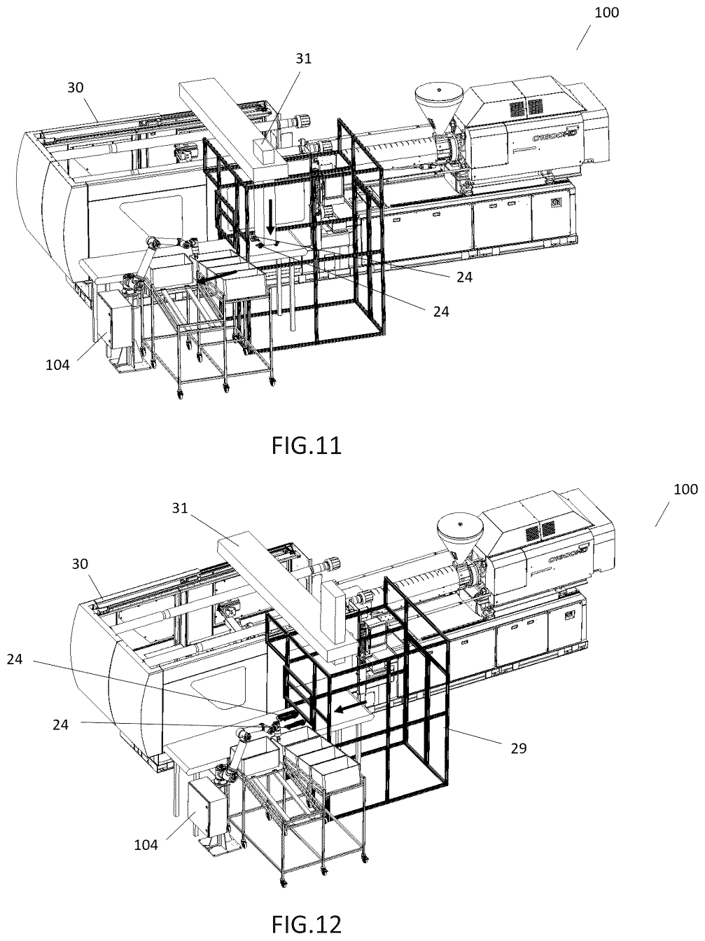

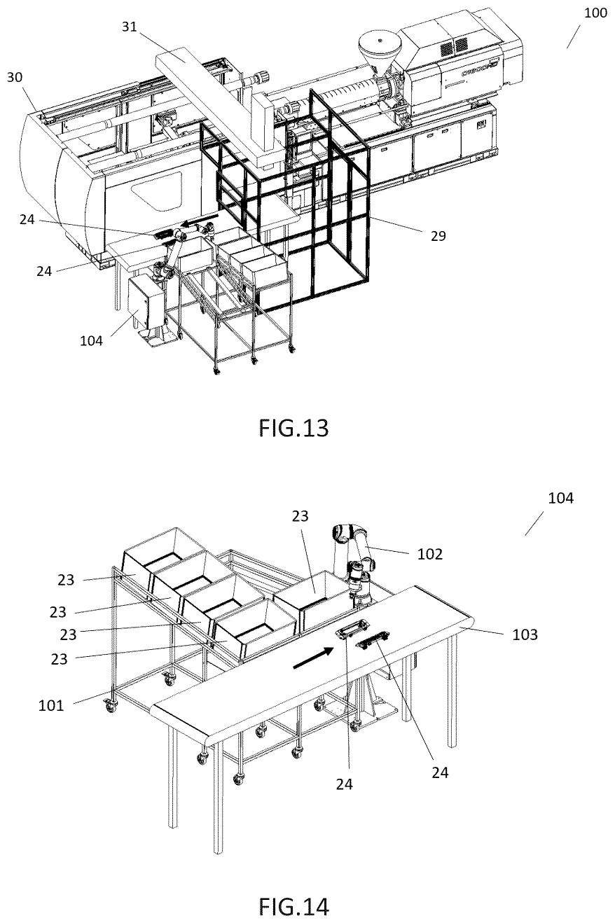

The pick-up arm 31 takes the molded parts 24 and lifts the parts out of the injection molding machine 30 (FIG. 9). Then, the pick-up arm 31 is moved into the safety cage 29 (FIG. 10) over the conveyor table 103 of the automated tote transfer system 104. The pick-up arm 31 is then lowered to release the molded parts 24 onto the conveyor table 103 (FIG. 11). The conveyor belt 27 moves the molded parts 24 to other end of the conveyor table 103 allowing the molded parts 24 to cool (FIGS. 12 and 13).

FIG. 14 through FIG. 27 show the process of the automated tote transfer system 104.

The automated tote transfer system 104 comprises a conveyor frame 101, a conveyor table 103, and a robot arm 102, and handles totes 23 and molded parts 24 (FIG. 14).

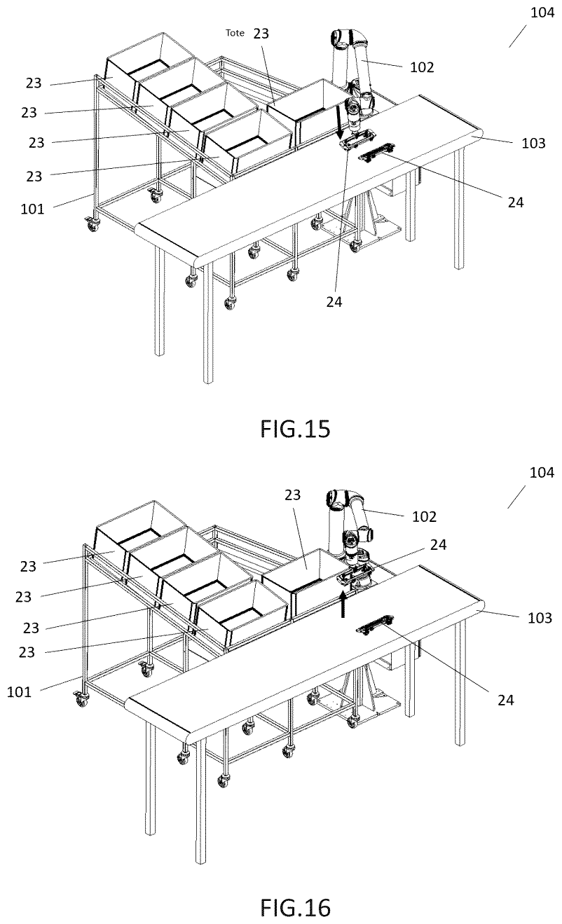

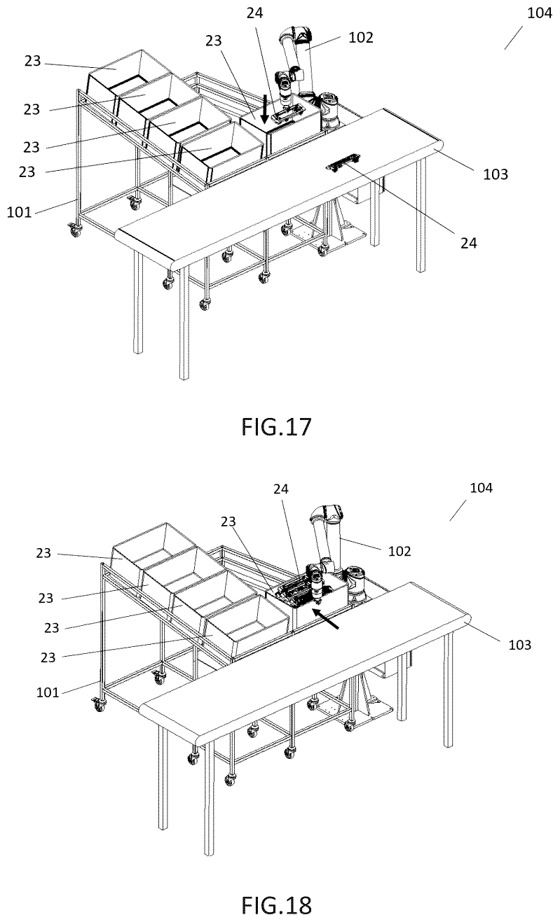

When the molded parts 24 reach the end of the conveyor table 103, on the opposite end of the safety cage 29, the robot arm 102 uses the lower arm 15, the upper arm 16 and the tool pivot 18 to articulate the control head 17 into position over the molded part 24 (FIG. 15). The control head 17 of the robot arm 102 rotates the tool holder 19 to position the grip head 21 to allow the grip fingers 22 to grip the molded part 24 (FIG. 16). The robot arm 102 then articulates through its programing to place the molded part into the tote 23 located on the platform 4 of the conveyor frame 101 (FIG. 17). This process is repeated to place other molded parts in the tote 23 (FIG. 18).

The process of the pick-up arm 31 removing molded parts 24 from the injection molding machine 30, placing them on the conveyor table 103, and moving the molded parts 24 to the robot arm 102 is repeated until the tote 23 is full of molded parts 24.

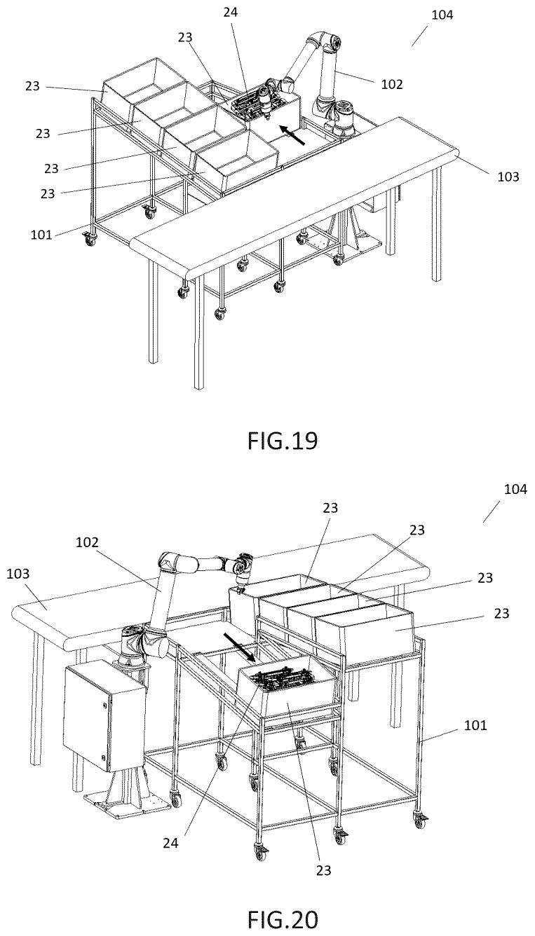

When the tote 23 on the platform 4 of the conveyor frame is full, the robot arm 102 places the tool holder 19 of the control head 17 on the front face of the tote 23 and pushes the tote 23 reward towards the lower ramp 3 (FIG. 19) causing the tote 23 to slide along the rollers 8 of the lower ramp 3 until it stops on the lower stop 11 (FIG. 20).

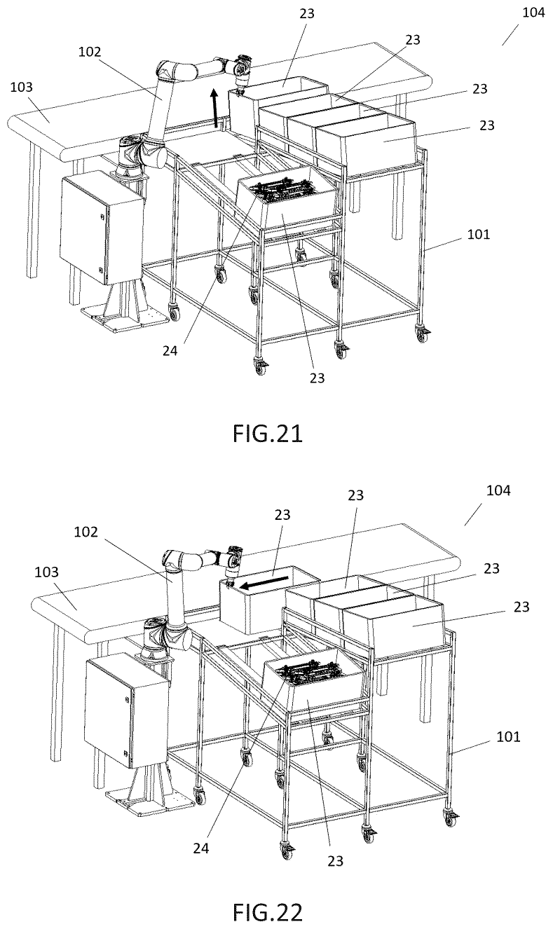

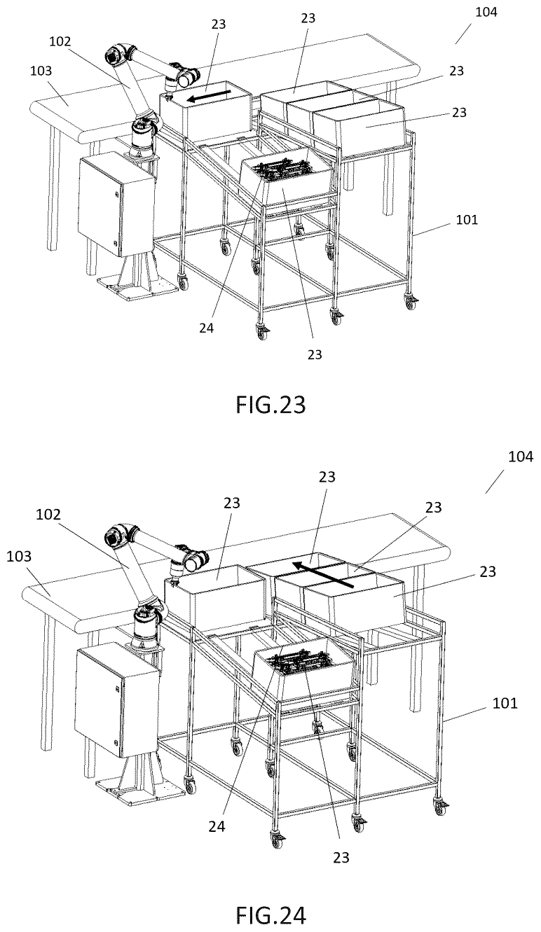

The robot arm 102 then reaches over and grabs the side wall of the tote 23 in the lowest position of the upper ramp 2 lifting the tote 23 above the top surface of the platform 4 (FIG. 21) and pulling it onto the platform 4 (FIGS. 22 and 23). Gravity causes the empty totes 23 to slide down on the upper ramp 2 through the rollers 7 until they hit the upper stop 9 locating a new empty tote 23 in the lowest position on the upper ramp 2 (FIG. 24).

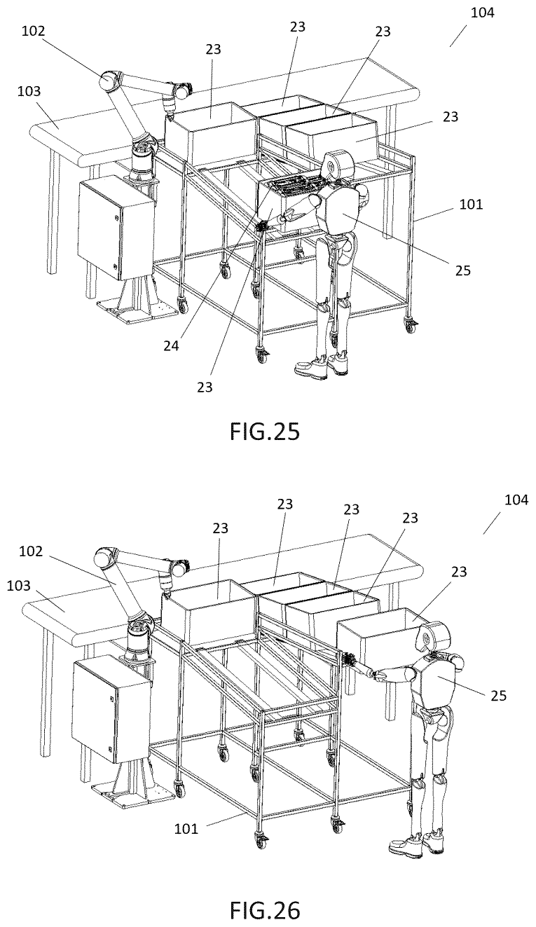

The operator 25 can remove the tote 23 full of molded parts 24 from the conveyor frame 101 (FIG. 25) and load an empty tote 23 into the entrance 10 of the conveyor frame 101 (FIG. 26).

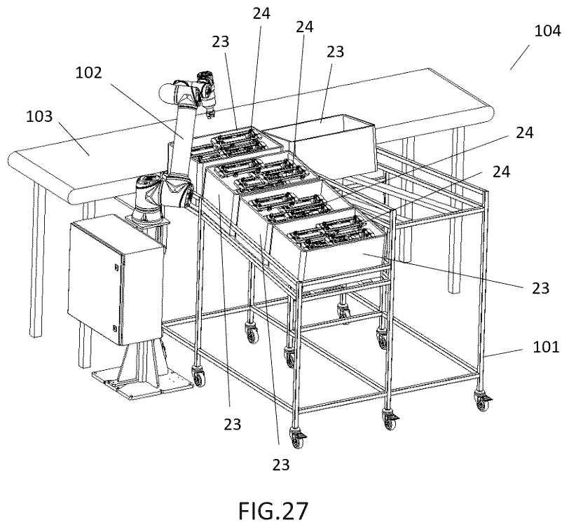

On the other hand, several totes 23 with full molded parts can be stored on the conveyor frame before the operator is required to remove them (FIG. 27).

The automated tote transfer system 104 is a modular system and can be moved from one injection molding machine 30 to another injection molding machine to pack the molded parts 24 with different size and shape. Multiple articulation programs can be stored and switched within the control unit 12.

While the invention has been explained with reference to the specific embodiments of the invention, the explanation is illustrative, and the invention is limited only by the appended claims.

What is claimed is:

1. An automated tote transfer system, comprising:
a frame structure including a platform located on one side of the frame structure, an upper ramp extending obliquely upwardly from the platform and having rollers along a length thereof, a lower ramp extending obliquely downwardly from the platform on one side of the upper lamp and having rollers, and guide rails provided above top edges of the lower ramp, the platform and the upper ramp, and
a robot located adjacent the platform, the robot being configured to pick up parts transferred to the frame structure, to put into totes located on the frame structure, and to move the totes on the frame structure.

2. The automated tote transfer system according to claim 1, further comprising a conveyer table with a powered conveyor belt running across a top thereof and configured to deliver the parts from one side of the conveyer table to another side thereof to be picked up by the robot.

3. The automated tote transfer system according to claim 2, further comprising a pick-up device located adjacent to the conveyer table, and configured to pick-up the parts and deliver the parts onto the conveyer table.

4. The automated tote transfer system according to claim 3,
wherein the pick-up device is configured to pick-up the parts and place the parts onto the conveyer table,
the parts on the conveyer table is configured to be transferred from the one side of the conveyer table to the another side, and
the robot is configured to pick-up the parts on the conveyer table, and to put the parts into the toes delivered from the upper lamp to the platform and to transfer the toes to the lower lamp.

5. The automated tote transfer system according to claim 2, wherein the conveyor table has wheels attached thereto to move the conveyor table.

6. The automated tote transfer system according to claim 1, wherein the frame structure has wheels attached thereto to move the frame structure.
